(19) United States
(12) Patent Application Publication
(10) Pub. No.: US 2005/0161235 A1
(43) Pub. Date: Jul. 28, 2005

(54) System for and method of stopping and extinguishing forest fires

(76) Inventor: Valery Chuprin, Brooklyn, NY (US)

Correspondence Address: Ilya Zborovsky, 6 Schoolhouse Way, Dix Hills, NY, 11746, US

(21) Appl. No.: 10/763,909

(22) Filed: Jan. 26, 2004

(51) Int. Cl. A62C 2/00

(52) U.S. Cl. 169/48; 169/45

(57) ABSTRACT

Stopping and extinguishing forest fires includes erecting a substantially vertical wall, and making the wall of a fire-resistant material so that when a forest fire reaches the wall it can be stopped and/or extinguished.

### BACKGROUND OF THE INVENTION

The present invention relates to a system for and a method of stopping and extinguishing forest fires.

It is known to stop and extinguish forest fires by removing vegetation, in particular forest trees over large areas so that fire can not propagate from the area in which it is occurring to a new area. It is also known to apply anti-fire substances straight onto a corresponding areas, for example anti-fire foam and the like. It is believed that the existing systems and methods can be further improved.

### SUMMARY OF THE INVENTION

Accordingly, it is an object of the present invention to provide a system for and a method of stopping and extinguishing of forest fires, which are further improvements of the existing systems and methods.

In keeping with these objects, one feature of the present invention resides, briefly stated, in a method of stopping and extinguishing forest fires which includes the steps of erecting a substantially vertical wall; and making the wall of a fire-resistant material so that when a forest fire reaches the wall it can be stopped and/or extinguished.

It is also another feature of the present invention to provide a system for stopping and extinguishing forest fires which includes a substantially vertical wall made of a fire-resistant material so that when a forest fire reaches the wall it can be stopped and/or extinguished.

When the method is performed and the system is designed in accordance with the present invention, it provides efficient stopping and extinguishing of forest fires.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view showing a system for stopping and extinguishing forest fires in accordance with the present invention;

FIG. 2 is a view showing an erectable wall of the system in accordance with the present invention in its original condition as a roll;

FIG. 3 is a view showing a terrain on which the inventive system is implemented; and

FIG. 4 is a view showing a further embodiment of the inventive system.

### DESCRIPTION OF THE PREFERRED EMBODIMENTS

As shown in FIG. 1, a system for stopping and extinguishing forest fires which implements a method for stopping and extinguishing forest fires in accordance with the present invention includes a wall which is identified as a whole with reference numeral 1. The wall 1 is formed as a substantially vertical wall composed of a fire-resistant or a fire-proof material. The wall 1 can be composed of fire-proof fabric which is known in the art in various modifications, for example of a fire proof material which is used as uniforms for firemen, etc. It can be also composed of a material coated with a fireproof coating of various compositions, which are also well known in the art.

The system further includes a plurality of supports which are identified with reference numeral 2. The supports are placed on a ground at certain distances from one another along a prospective wall, and then the wall is attached to the supports. The attachment can be performed by known means. For example the vertical leg of the supports 2 can be provided with hooks and the wall 1 can be provided with loops which are fitted onto the hooks. Of course, other connecting concepts are possible as well.

When the wall 1 is erected substantially vertically across a terrain, then when a fire approaches the wall, due to fire-resistant nature of the wall, the fire can be stopped and extinguished.

In accordance with an additional feature of the present invention, an anti-fire substance, for example an anti-fire foam is applied behind the wall 1, for example on vegetation, such as on forest trees, as identified with reference numeral 3. It is possible in accordance with the present invention to first fall or cut the trees so that they fall on the ground and then to apply the foam 3 on them.

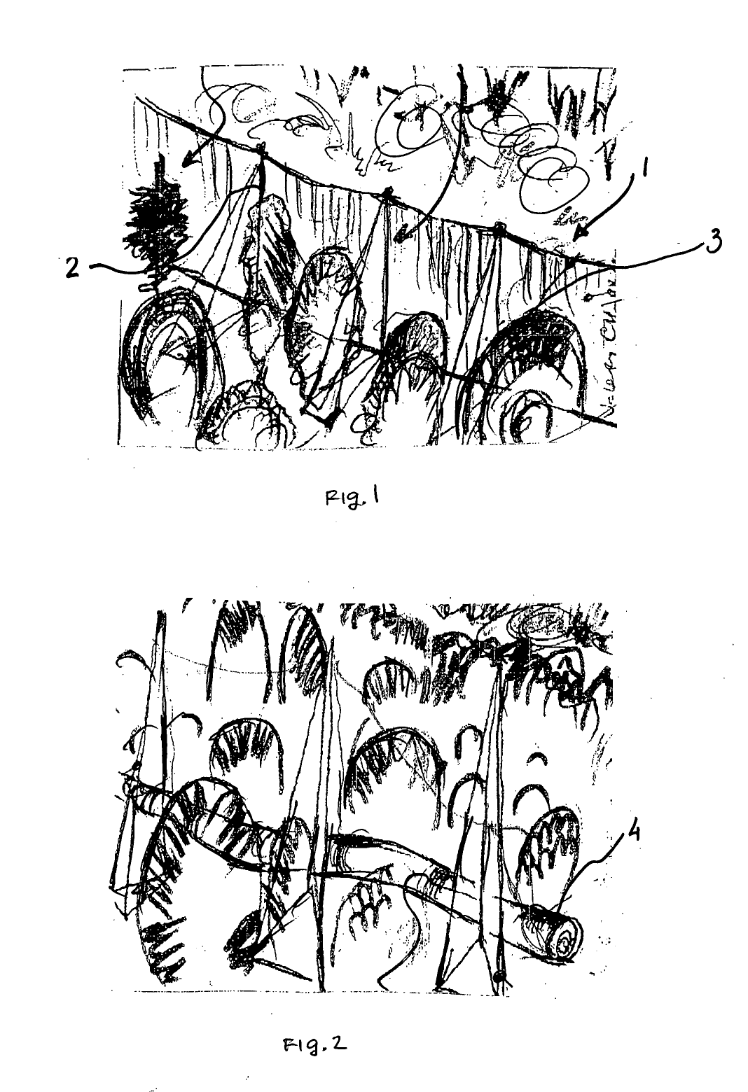

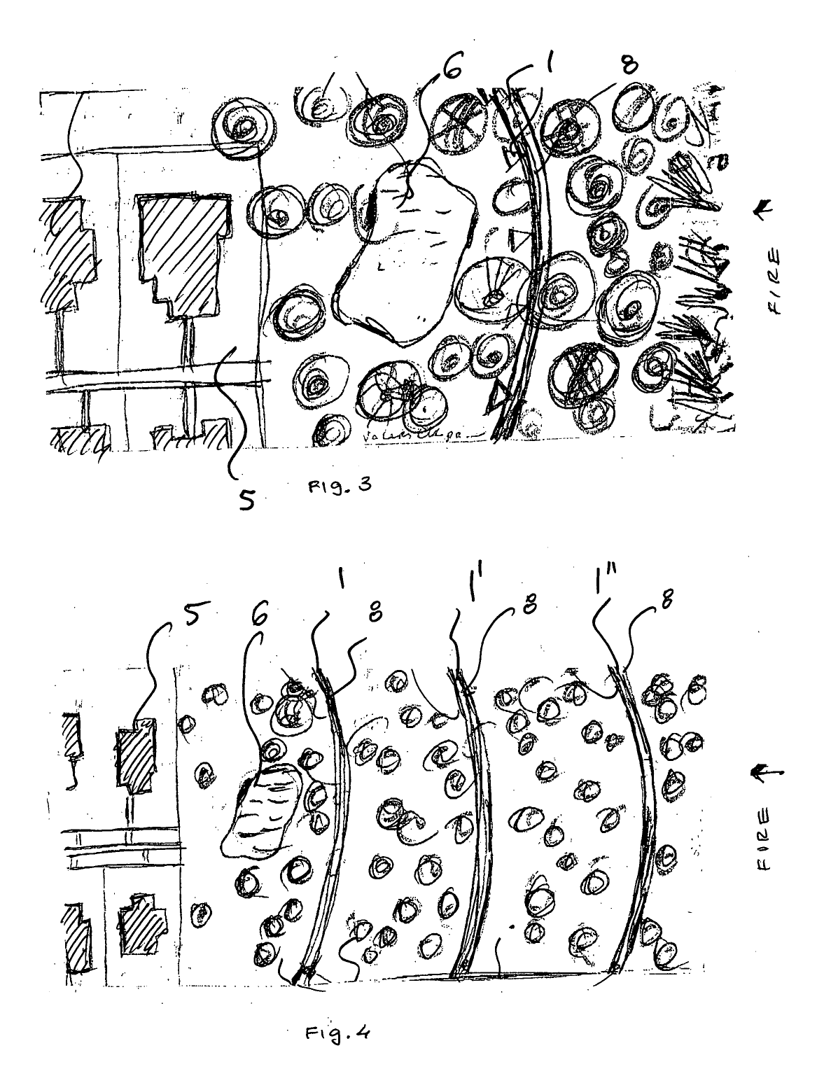

FIG. 2 is a view showing an initial stage of erecting the wall 1. Initially, the wall 1 is formed as a roll of the fire-resistant material as identified with reference numeral 4. The roll is placed along a corresponding line in the forest, then the supports 2 are installed, and then the roll 4 is unrolled so as to form the wall 1 and to attach it to the supports 2. This approach provides a portable construction which is easy to transport. The supports 2 together with the rolled wall 1 in the form of the roll 4 are convenient to transport to any location.

The wall can be of any shape or trajectory. As shown in FIG. 1, the wall 1 is installed in a curved fashion to protect a settlement 5 located behind the lake 6, at the rear side of the wall. In order to install the wall a road or a trench 8 can be made between the trees in the forest, and then the wall 1 in the form of the roll 4 is placed on the road or in the trench and unrolled and attached to the supports 2.

In accordance with a further feature of the present invention as shown in FIG. 4, a plurality of walls composed of fire-resistant material can be installed, as identified with reference numerals 1, 1′, 1″. In this case, the system includes several echelons of fire protection. If the first wall does not completely stop and extinguish the fire, then the second wall will, etc. The anti-fire foam 3 can be applied in the areas behind each of the walls 1, 1′, 1″.

When the system is designed and the method is performed in accordance with the present invention, it provides an efficient way to stop and extinguish forest fires.

It will be understood that each of the elements described above, or two or more together, may also find a useful application in other types of constructions differing from the types described above.

While the invention has been illustrated and described as embodied in system for and method of stopping and extinguishing of forest fires, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method of stopping and extinguishing forest fires, comprising the steps of erecting at least one substantially vertical wall; and making the wall of a fire-resistant material so that when a forest fire reaches the wall it can be stopped and/or extinguished.

2. A method as defined in claim 1; and further comprising erecting at least one further such wall composed of a fire resistant material, which is spaced at a predetermined distance from said first-mentioned wall.

3. A method as defined in claim 1; and further comprising placing a plurality of supports, said erecting including supporting said at least one wall on said plurality of supports.

4. A method as defined in claim 1; and further comprising providing said at least one wall of a fire resistant material initially as a roll of said fire resistant material, said erecting includes unrolling of said roll of a fire resistant material so as to erect at said wall.

5. A method as defined in claim 1; and further comprising applying an anti-fire foam material on an area located behind the wall.

6. A method as defined in claim 5, wherein said applying includes applying the anti fire foam material on vegetation located behind the at least one wall.

7. A method as defined in claim 5; and further comprising bringing vegetation behind the at least one wall to the ground, said applying includes applying the anti-fire foam onto the vegetation brought to the ground.

8. A method as defined in claim 1; and further comprising forming at least one trench, erecting includes placing the wall in the at least one trench.

9. A system for stopping and extinguishing of forest fires, comprising at least one substantially vertical wall; said wall being made of a fire-resistant material so that when a forest fire reaches the wall it can be stopped and/or extinguished.

10. A system as defined in claim 9; and further comprising at least one further such wall composed of a fire resistant material, which is spaced at a predetermined distance from said first mentioned wall.

11. A system as defined in claim 9; and further comprising a plurality of supports, said at least one wall being supported on said plurality of supports.

11. A system as defined in claim 9, wherein said at least one wall of afire resistant material initially is formed as a roll of said fire resistant material, which is subsequently unrolled so as to erect at said wall.

12. A system as defined in claim 9; and further comprising an anti-fire foam material applied on an area located behind the wall.

13. A system as defined in claim 12, wherein the anti fire foam material is appliable on vegetations located behind the at least one wall;

14. A system as defined in claim 11, wherein the vegetation behind the at least one wall is brought to the ground, said the anti-fire foam is applied onto the vegetation brought to the ground.

15. A system as defined in claim 9; and further comprising at least one trench, said wall is arranged in the at least one trench.
